(19) United States
(12) Patent Application Publication
(10) Pub. No.: US 2010/0257187 A1
(43) Pub. Date: Oct. 7, 2010

(54) METHOD OF ANNOTATING A RECORDING OF AT LEAST ONE MEDIA SIGNAL

(75) Inventors: Wilhelmus Franciscus Johannes Fontijn, Eindhoven (NL); Alexander Sinitsyn, Eindhoven (NL); Steven Broeils Luitjens, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., EINDHOVEN (NL)

(21) Appl. No.: 12/746,203

(22) PCT Filed: Dec. 11, 2007
(86) PCT No.: PCT/IB08/55137

§ 371 Date: Jun. 4, 2010

(30) Foreign Application Priority Data
Dec. 11, 2007 (EP) 07122832.4

(51) Int. Cl. G06F 17/30

(52) U.S. Cl. 707/756; 707/736; 707/E17.009

(57) ABSTRACT

In a method of annotating a recording of at least one media signal (22,23), the recording relates to at least one time interval during which corresponding physical signals have been captured. The method includes augmenting the at least one media signal (22,23) with information (17) based on data (14-16) representative of values of at least one physical parameter in an environment at a physical location associated with the recording and pertaining at least partly to points in time outside the at least one time interval.

### FIELD OF THE INVENTION

The invention relates to a method of annotating a recording of at least one media signal,

wherein the recording relates to at least one time interval during which corresponding physical signals have been captured,

which method includes augmenting the at least one media signal with information based on data representative of values of at least one physical parameter in an environment at a physical location associated with the recording.

The invention also relates to a system for annotating a recording of at least one media signal, which recording relates to at least one time interval during which corresponding physical signals have been captured, which system includes:

a signal processing system for augmenting the at least one media signal with information; and

an interface to at least one sensor for measuring at least one physical parameter in an environment at a physical location associated with the recording.

The invention also relates to a computer programme.

### BACKGROUND OF THE INVENTION

US 2006/0149781 discloses metadata text files that can be used in any application where a location in a media file or even a text file can be related to sensor information. This point is illustrated in an example in which temperature and humidity readings from sensors are employed to find locations in a video that teaches cooking. The chef prepares a meal using special kitchen utensils such as pitchers rigged to sense if they are full of liquid, skillets that sense their temperature, and cookie cutters that sense when they are being stamped. All of these kitchen utensils transmit their sensor values to the video camera, where the readings are recorded to a metadata text file. The metadata text file synchronises the sensor readings with the video. When this show is packaged commercially, the metadata text file is included with the video for the show.

A problem of the known method is that, for all relevant sensor information to be provided with the video, the video recording itself must be very long. If only sensor data captured during the actually recorded video segments are packaged with the video, then information will be missing that could be relevant to the user for determining the conditions prevailing at the location where the video was shot.

### SUMMARY OF THE INVENTION

It is an object of the invention to provide a method of annotating a recording of at least one media signal, a system for annotating a recording of at least one media signal, and a computer programme, which are suitable for conveying information relating to the circumstances of the production of the annotated recording in a relatively accurate and efficient manner.

This object is achieved by the method of annotating a recording of at least one media signal according to the invention, which method includes augmenting the at least one media signal with information based on data representative of values of at least one physical parameter in an environment at a physical location associated with the recording and pertaining at least partly to points in time outside the at least one time interval.

Because the recording is augmented with information based on data representative of values of at least one physical parameter in an environment at a physical location associated with the recording, information relating to the circumstances of the production of the annotated recording can be provided. It is possible in principle to re-create those circumstances, at least to an approximation, based on that information. This provides for a more engaging playback of the media signals. Because the information is based on parameter values pertaining at least partly to points in time outside the at least one time interval, the information is more accurate. It also covers periods not covered by the media signal, e.g. intervals edited out of the media signal or periods just prior or after the media signal was captured. Thus, the capture of the media signal and the capture of the sensor data for creating the annotating information are decoupled.

An embodiment of the method includes interpreting the parameter values to transform the parameter values into the information with which the at least one media signal is augmented.

Interpretation of parameter values prior to addition of annotating information allows for a reduction of information. An effect is to make the annotation more efficient.

An embodiment of the method includes receiving at least one stream of parameter values and transforming the at least one stream of parameter values into a data stream having a lower data rate than the at least one stream of parameter values.

An effect is to provide a form of interpretation that results in values covering longer time intervals than those to which the parameter values pertain. This embodiment is suitable for characterising an atmosphere at a location at which the physical signals corresponding to the media signals have been captured or rendered, since environmental conditions generally do not vary on the same short-term time scale as media signals.

A further variant includes transforming a plurality of sequences of parameter values into a single data sequence included in the information with which the at least one media signal is augmented.

An effect is to make the annotating information more accurate whilst keeping the amount of annotating information to an acceptable level.

An embodiment of the method of annotating a recording includes obtaining sensor data by measuring a physical parameter in an environment at a physical location at which the physical signals corresponding to the at least one media signal are captured, and augmenting the at least one media signal with information based at least partly on the thus obtained sensor data.

An effect is to provide information describing the ambient conditions at a location of recording. Such information is thus in harmony with the impression of the ambient conditions conveyed by the media signal. The annotated recording is suited to re-creating the ambient conditions, or at least reinforcing an impression of the ambient conditions at playback of the recorded media signal or media signals.

In an embodiment, the parameter values pertain to points in time within at least part of a time interval encompassing the at least one time interval during which the corresponding physical signals are captured.

An effect is to ensure that the media signals are annotated with information that is relevant to the at least one time interval during which the corresponding physical signals have been captured. Nevertheless, the risk of adding redundant information is relatively low, because the information is based on parameter values pertaining at least partly to points in time outside that at least one time interval.

An embodiment of the method includes obtaining sensor data by measuring at least one physical parameter representative of a physical quantity different from that represented by the physical signals corresponding to the at least one media signal.

An effect is to augment the recording with relatively relevant data. Information based on physical parameters representative of a physical quantity different from that represented by the physical signals corresponding to the at least one media signal cannot be readily inferred from the at least one media signal.

According to another aspect, the system according to the invention for annotating a recording of at least one media signal includes:

a signal processing system for augmenting the at least one media signal with information; and

an interface to at least one device for determining values of at least one physical parameter in an environment at a physical location associated with the recording,

wherein the system is capable of obtaining data representative of parameter values from the at least one device outside the at least one time interval, and of augmenting the at least one media signal with information based at least partly on those data.

Because the system includes an interface to at least one device for determining values of at least one physical parameter in an environment at a physical location associated with the recording, the system is capable of capturing data representative of ambient conditions at the time the annotated recording was produced. At least an impression of these conditions can be given by a suitable system when the annotated recording is played back. Because the system is capable of obtaining data representative of the physical parameter values outside the at least one time interval and of augmenting the recording with information based at least partly on that data, comprehensive information is provided relatively efficiently.

In an embodiment, the system is configured to carry out a method of annotating a recording of at least one media signal according to the invention.

In this embodiment, the system is configured automatically to ensure that the at least one media signal is augmented with information based on data representative of values of at least one physical parameter in an environment at a physical location associated with the recording and pertaining at least partly to points in time outside the at least one time interval.

According to another aspect of the invention, there is provided a computer programme including a set of instructions capable, when incorporated in a machine-readable medium, of causing a system having information processing capabilities to perform a method according to the invention.

### BRIEF DESCRIPTION OF THE DRAWINGS

The invention will be explained in further detail with reference to the accompanying drawings, in which:

FIG. 1 is a schematic diagram of a recording system;

FIG. 2 is a state diagram of a recording process carried out using the recording system of FIG. 1; and

FIG. 3 is a schematic diagram of a home entertainment system.

### DETAILED DESCRIPTION OF THE EMBODIMENTS

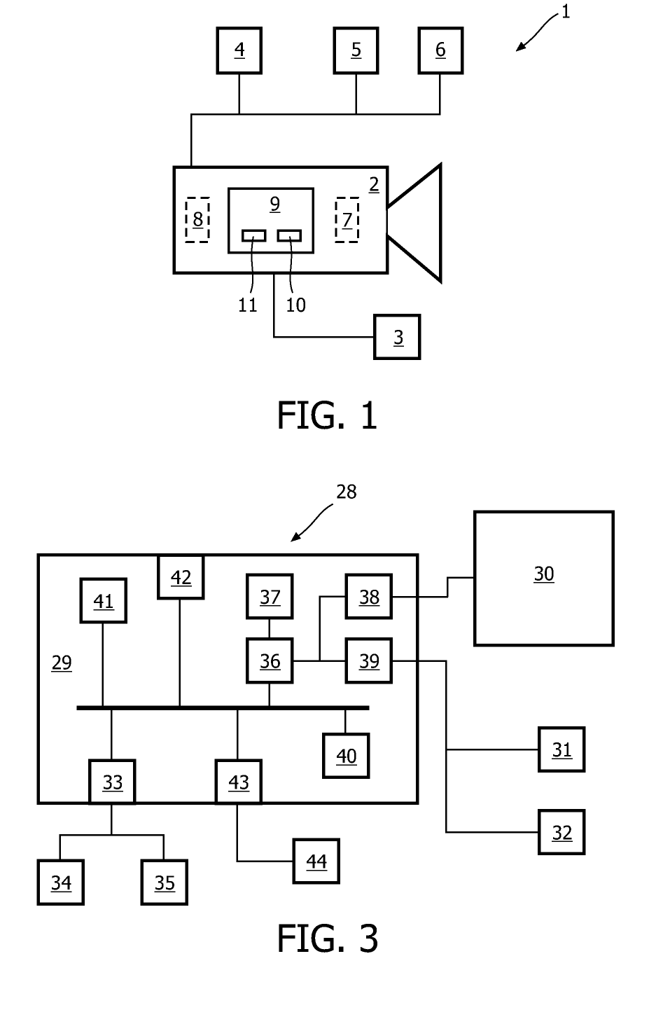

Referring to FIG. 1, an example of a recording system 1 for capturing physical signals to create an annotated recording of one or more media signals is shown. The recording system 1 comprises a video camera 2, a microphone 3 and first, second and third sensors 4-6.

In the illustrated embodiment, the video camera 2 includes a light-sensitive sensor array 7 for converting light intensity values into a digital video data stream. Generally, the digital video data stream will be encoded and compressed, synchronised with a digital audio data stream and recorded to a recording medium in a recording device 8, together with the digital audio data stream. The media signals are augmented with annotation information based on data representative of values of at least one physical parameter in an environment at the recording location. In this context, a physical parameter is a value of some physical quantity, i.e. a quantity relating to forces of nature.

The video camera 2 includes a user interface in the form of a touch screen interface 9. It includes a first user control 10 for starting and stopping the capture of video and audio signals. It further includes a second user control 11 for starting and stopping the capture of annotation information based on data representative of at least one physical parameter at the recording location.

In the illustrated embodiment, at least one of the sensors 4-6 is provided for measuring at least one physical parameter representative of a physical quantity different from that represented by the physical signals corresponding to the digital audio and video signals. Thus, since the video and audio signals are representative of light intensity and acoustic energy, the first sensor 4 can measure temperature, the second sensor 5 can measure humidity and the third sensor 6 can measure vibration, for example. In other embodiments, fewer or no sensors 4-6 are present, and the annotating information is based on e.g. the signal from the microphone 3. In another embodiment, at least one of the sensors 4-6 measures a physical parameter representative of a similar quantity to those captured by the digital audio and video signals. For example, one of the sensors 4-6 can measure the ambient light intensity.

In another embodiment, values are obtained from a system for regulating devices arranged to adjust ambient conditions, e.g. a background lighting level. Thus, in these embodiments this aspect of ambient conditions is not measured directly. There may be a combination with sensor data, e.g. where a sensor measures wind speed and the settings for regulating floodlighting are collected also.

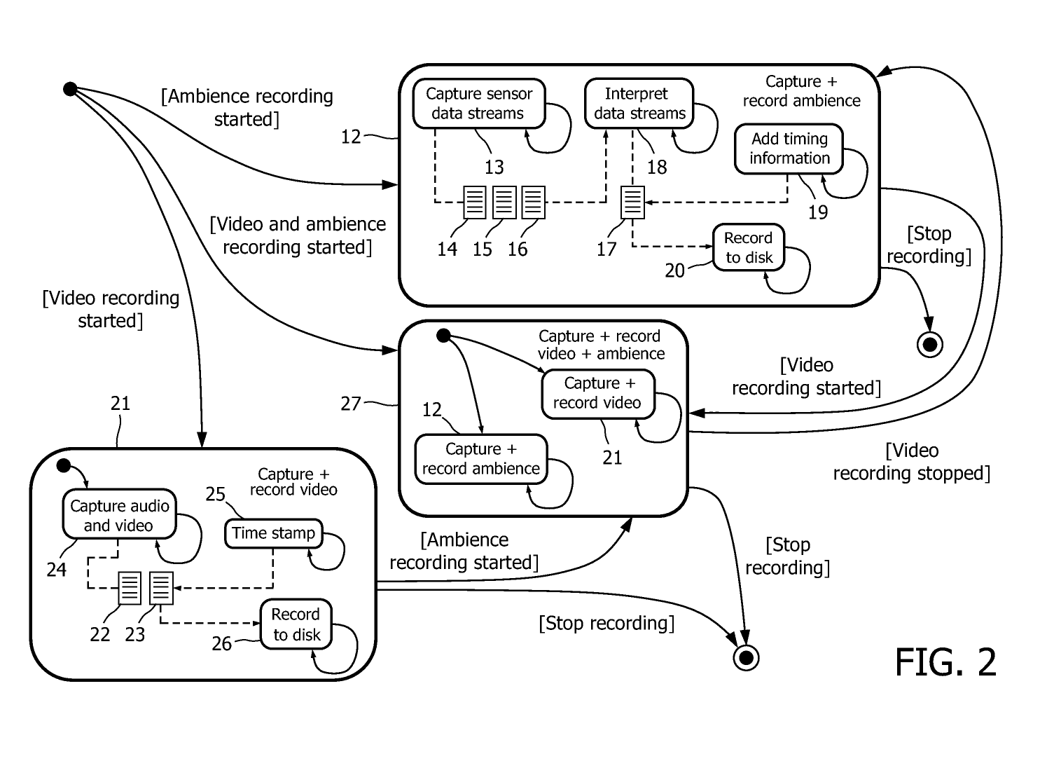

Some states of the recording system 1 are shown in FIG. 2. Typically, an operator will use the second user control 11 to commence capture and recording of the ambience at the scene of recording (state 12). The video camera 2 continually captures (state 13) streams 14-16 of parameter values received through its interface to the three sensors 4-6. These three streams 14-16 of data values are reduced to a single set 17 of ambience data values. The reduction comprises interpreting the streams of parameter values (state 18) and adding timing information (state 19), prior to recording the ambience information to the recording medium (state 20). The latter state 20 comprises recording the ambience information in text format, e.g. in xML (eXtensible Markup Language) format in a file.

In one embodiment, the three streams 14-16 of parameter values are reduced to a stream of ambience values, each value representative of an ambience at a corresponding point in time. Timing information to relate each ambience value to a point in time is added.

In another embodiment, the timing information serves to identify the time interval over which the ambience was determined, so that the ambience information relates to the entire duration of the state 12. In another embodiment, the first and second streams 14,15 are reduced to a time-stamped sequence of ambience values and the first, second and third stream 16 are interpreted to arrive at a set of data characterising a further aspect of the ambience over the duration of the state 12 of capturing the ambience.

Even if a series of time-stamped ambience values is generated, the data rate is still generally lower than that of the streams 14-16 of parameter values, by which is meant that the ambience values pertain to longer time intervals than the parameter values.

FIG. 2 also shows a state 21 in which only media signals are recorded. An audio stream 22 and a video stream 23 are captured (state 24). They are synchronised (state 25) using timing information, and recorded on a recording medium in the recording device 8 (state 26).

The general progression from and to the state 12 of capturing ambience data serves to provide in a relatively simple way more reliable information on the ambience at a recording location. The normal progression is from the state 12 of capturing and recording the ambience to a state 27 of capturing and recording both the audiovisual signals and the ambience and back again to the state 12 of capturing and recording the ambience, as the user actuates the first user control 10 to record video segments. The ambience data is based also on parameter values pertaining to points in time within the intervening time intervals, as well as points in time within the time interval preceding the recording. In an embodiment, this is automated by appropriate programming of the video camera 2.

In another embodiment, the set 17 of ambience information is based on values of the signal from the microphone 3, and the sensors 4-6 are not used. Because the ambience information is based on values of the microphone signal pertaining to points in time outside the time intervals of recording the audio signal, the overall information content of the annotated recording is still enhanced. Moreover, the microphone signal is interpreted to derive information representative of an ambience (as opposed to acoustic energy). For example, the ambience information can result from a determination of the average background noise level over a time interval encompassing the time intervals during which the recorded audio and video signals were captured.

FIG. 3 illustrates a home entertainment system 28 including a home theatre 29 a television set 30 and speakers 31,32. The home theatre 29 is controlled by a data processing unit 36 for manipulating data held in main memory 37.

A video output stage 38 provides a decoded video signal to the television set 30. An audio output stage 39 provides analogue audio signals to the speakers 31,32.

The home theatre 29 further includes an interface 33 to first and second peripheral devices 34,35 for adjusting physical conditions in an environment of the home entertainment system 28. These peripheral devices 34,35 are representative of a class of devices including lights adapted to emit light of varying colour and intensity; fans adapted to provide an airflow; washer light units for providing back-lighting varying in intensity and colour; and rumbler devices allowing a user to experience movement and vibration. Other sensations such as smell may also be provided. The data processing unit 36 controls the output of the peripheral devices 34,35 via the interface 33 by executing instructions encoded in scripts, for example scripts in a dedicated (proprietary) mark-up language. The scripts include timing information and information representative of settings of the peripheral devices 34,35.

Media signals are accessed by the home theatre 29 from an internal mass storage device 40 or from a read unit 41 for reading data from a recording medium, e.g. an optical disk. The home theatre 29 is also capable of receiving copies of recordings of media signals via a network interface 42.

The home theatre 29 can obtain media signals annotated with scripts indicating the settings for the peripheral devices 34,35, in a manner known per se. However, the home theatre 29 can also obtain media signals annotated with information of the type created using the method illustrated in FIG. 2. In that case, the home theatre 29 obtains the script itself by interpreting the information annotating the media signal according to certain rules to determine at least one target ambience, and by then transforming the target ambience or ambiences into settings for the peripheral devices 34,35, and optionally into settings for the audio output stage 39, speakers 31,32, or other components of the system for rendering the audiovisual signal.

For example, the annotated recording can be one obtained at an airfield. Even if there is no footage of an aeroplane taking off or coming in to land, the annotating information will still indicate a noisy ambience. This is because the ambience data is based on values of at least one physical parameter (such as noise level) pertaining at least partly to points in time outside the time interval of recording. The home theatre 29 translates the information indicating a noisy ambience into a script for regulating the peripheral devices 34,35 to re-create the ambience, e.g. to create a vibrating sensation and to add the sound of aeroplanes to the audio track comprised in the media signals.

The home theatre 29 employs a database relating particular ambiences to particular settings and/or particular parameter values in algorithms for creating settings in dependence on characteristics of the media signals.

In an embodiment, the home entertainment system 28 is further configured to carry out a method as illustrated in FIG. 2. In particular, it is able to augment media signals with information based on data representative of values of at least one physical parameter in an environment at a physical location associated with a recording of the media signals being processed by it and corresponding to the location at which the media signals are rendered. Quite obviously, such parameter values pertain to points in time outside the time intervals of recording the media signals originally. The home theatre 29 includes an interface 43 to a sensor 44 similar to the sensors 4-6 of the recording system 1 of FIG. 1. Thus, in this embodiment, a recording of media signals can be augmented with annotating information representing the ambience at the time of first rendering the media signals, so that that ambience can be re-created at a later time.

The embodiments discussed above in detail demonstrate the properties of the method of annotating a recording of at least one media signal. These properties also characterise other embodiments (not illustrated) of the method. For example, a mobile phone may operate as a recording system, being fitted with a camera for obtaining a media signal in the form of a digital image, as well as a microphone. The sound information is not recorded, but the sound signal over an interval encompassing the point in time at which the image was captured may be analysed to determine an ambience. For example, where a digital image is captured at a football match, the sound signal may be analysed to determine automatically the mood of the crowd.

In another embodiment, a distributed recording system is used. Data representative of values in a city are obtained whilst digital images are captured using wireless communications to networked sensors distributed about the city. Data representative of music listened to in the course of a time interval during which the digital images were captured are also analysed. The totality of data are analysed to derive information representative of the mood the user was in whilst the digital images were captured and/or the ambience in the city.

Each of these embodiments allows the media signals to be augmented with information based on parameter values that are not directly derivable from the media signals themselves. Each of these embodiments achieves this in an efficient manner by interpreting parameter values to infer an ambience or mood, rather than recording additional signals from sensors. In each of these embodiments, the information representative of the ambience or mood is based at least partly on parameter values pertaining to points in time outside the recording intervals, so that the reliability of the annotating information is enhanced.

It should be noted that the embodiments described above illustrate rather than limit the invention, and that those skilled in the art will be able to design many alternative embodiments without departing from the scope of the appended claims. In the claims, any reference signs placed between parentheses shall not be construed as limiting the claim. Use of the verb “comprise” and its conjugations does not exclude the presence of elements or steps other than those stated in a claim. The article “a” or “an” preceding an element does not exclude the presence of a plurality of such elements. The invention may be implemented by means of hardware comprising several distinct elements, and by means of a suitably programmed computer. In the device claim enumerating several means, several of these means may be embodied by one and the same item of hardware. The mere fact that certain measures are recited in mutually different dependent claims does not indicate that a combination of these measures cannot be used to advantage.

Instead of recording media signals on a physical disk and providing the physical disk or copies thereof to a system for rendering the at least one media signal, the media signal and annotating information may be recorded temporarily in a memory device, e.g. a solid-state memory device or hard disk unit, and then communicated via a network.

‘Means’, as will be apparent to a person skilled in the art, are meant to include any hardware (such as separate or integrated circuits or electronic elements) or software (such as programs or parts of programs) which perform in operation or are designed to perform a specified function, be it solely or in conjunction with other functions, be it in isolation or in co-operation with other elements. ‘Computer programme’ is to be understood to mean any software product stored on a computer-readable medium, such as an optical disk, downloadable via a network, such as the Internet, or marketable in any other manner.

1. Method of annotating a recording of at least one media signal (22,23),
wherein the recording relates to at least one time interval during which corresponding physical signals have been captured,
which method includes augmenting the at least one media signal (22,23) with information (17) based on data (14-16) representative of values of at least one physical parameter in an environment at a physical location associated with the recording and pertaining at least partly to points in time outside the at least one time interval.

2. Method according to claim 1, including interpreting the parameter values (14-16) to transform the parameter values (14-16) into the information (17) with which the at least one media signal (22,23) is augmented.

3. Method according to claim 2, including receiving at least one stream (14-16) of parameter values and transforming the at least one stream (14-16) of parameter values into a data stream (17) having a lower data rate than the at least one stream of parameter values.

4. Method according to claim 2, including transforming a plurality of sequences (14-16) of parameter values into a single data sequence included in the information (17) with which the at least one media signal (22,23) is augmented.

5. Method according to claim 1, including obtaining sensor data by measuring a physical parameter in an environment at a physical location at which the physical signals corresponding to the at least one media signal are captured, and augmenting the at least one media signal (22,23) with information (17) based at least partly on the thus obtained sensor data.

6. Method according to claim 1, wherein the parameter values (14-16) pertain to points in time within at least part of a time interval encompassing the at least one time interval during which the corresponding physical signals are captured.

7. Method according to claim 1, including obtaining sensor data by measuring at least one physical parameter representative of a physical quantity different from that represented by the physical signals corresponding to the at least one media signal.

8. System for annotating a recording of at least one media signal (22,23), which recording relates to at least one time interval during which corresponding physical signals have been captured, which system includes:
a signal processing system (2;29) for augmenting the at least one media signal (22,23) with information (17); and
an interface (33) to at least one device (4-6;44) for determining values of at least one physical parameter in an environment at a physical location associated with the recording,
wherein the system is capable of obtaining data (14-16) representative of parameter values from the at least one device (4-6;44) outside the at least one time interval, and of augmenting the at least one media signal (22,23) with information (17) based at least partly on those data (14-16).

9. System according to claim 8, configured to carry out a method according to claim 1.

10. Computer programme, including a set of instructions capable, when incorporated in a machine-readable medium, of causing a system having information processing capabilities to perform a method according to claim 1.
